(19) United States
(12) Patent Application Publication
(10) Pub. No.: US 2007/0159606 A1
(43) Pub. Date: Jul. 12, 2007

(54) Theatre hall projection

(75) Inventor: Jos Striedl, Munchen (DE)

Correspondence Address: Jennifer H Hamilton;The Eclipse Group, Suite 300, 10605 Balboa Boulevard, Granada Hills, CA, 91344, US

(73) Assignee: VR SPACE THEATRES GMBH, Munchen (DE)

(21) Appl. No.: 10/549,011

(22) PCT Filed: Mar. 13, 2003
(86) PCT No.: PCT/EP03/02622

§ 371 Date: Dec. 4, 2006

(51) Int. Cl. G03B 21/26

(52) U.S. Cl. 353/94

(57) ABSTRACT

The invention relates to a theatre hall comprising a wall (2) with a circular cross-section formed by several adjacent defining projection surfaces (3) and comprising projectors (6). At least one projector (6) is associated with each projection surface (3). The theatre hall also has a dome-shaped hall ceiling (17) and several projectors (18) are associated therewith. All of the projectors (6, 18) can be controlled by a common control centre unit (15) in such a manner that a merging overall picture is produced on the wall (2) with a circular cross-section and on the dome-shaped hall ceiling (17). The theatre hall further comprises devices (10) for influencing the central control unit (15).

This invention relates to a theatre hall comprising a wall with a circular cross-section formed by adjacent defining projection surfaces and a dome-shaped ceiling.

Normally, cinema halls contain projection surfaces formed as a screen, which largely cover one wall of the hall with a rectangular cross-section. One or more projectors are normally installed on or a behind the opposite wall of the hall for projection of individual pictures or films onto the screen.

From DE 1 203 127 B a projection device is known with an internally mountable hollow dome and a number of projection apparatuses, whereby the projection apparatuses project pictures onto the projection surfaces and the projection surfaces are translucent. Furthermore, the projection apparatuses are arranged on the outside of the projection surfaces and spaced from them such that the pictures are projected onto the back of the projection surfaces.

DE 100 21 981 B relates to a theatre hall with walls formed by projection surfaces and picture projectors, of which in each case at least one is assigned to each projection surface. Here, at least some walls of a number of adjacent projection surfaces are each formed with assigned projectors and the projectors can be controlled from a common central control unit such that a continuous cinema picture arises on the projection surfaces. At least some audiences seats some operational controls for influencing the central control unit are provided and by means of a priority controller, the first operated operational control always has priority for a certain intervention. The audience seats are formed as rotating seats.

The object of the invention is to provide a theatre hall which enables an effective three-dimensional picture impression to be given to an audience which is as large as possible. Here, the picture impression should not occur exclusively on the walls of the theatre hall and it should not be limited in the upwards direction. A further object of this invention is to render the overall picture created in the whole theatre hall surrounding the audience such that it can be influenced by a participant in the audience, providing the participant with an interactive picture impression.

This object is solved according to the invention by a theatre hall comprising a wall with a circular cross-section formed by several adjacent defining projection surfaces and comprising projectors, whereby one projector is assigned to each projection surface, and with a dome-shaped ceiling to which several projectors are assigned, whereby all projectors can be controlled from a common central control unit such that a complete picture arises on the wall, which is circular in cross-section, and on the dome-shaped hall ceiling, and with devices for influencing the central control unit.

Due to construction of the wall, which is circular in cross-section, in the round theatre hall comprising several adjacent defining projection surfaces, advantageously any size of the theatre hall can be produced which, apart from a large audience, can accommodate one or more stages.

The arrangement of the wall formed from the projection surfaces in combination with the dome-shaped hall ceiling, which is also suitable for the projection of pictures of films, enables the generation of a picture completely surrounding the auditorium. The hall wall in conjunction with the vaulted imaging system of the dome-shaped hall ceiling enable the generation of scenes with a high degree of reality, because the scene is offered to the observer from many directions at once and not, as with most conventional imaging systems, just from one single flat plane.

The complete picture on the wall and the dome-shaped hall ceiling is, according to the invention, generated by a large number of projectors. Each of the adjacent bordering projection surfaces, forming in each case a section of the wall of the theatre hall, is assigned to at least one projector. The pictures of these individual projectors are generated such that they overlap one another and give a continuous picture over the whole wall of the theatre hall according to the invention without the audience being aware of the transition regions. Similarly, pictures are generated on the dome-shaped ceiling by several projectors assigned to the hall ceiling.

In one embodiment of the invention the whole picture, which is created on the wall, which is circular in cross-section, and on the dome-shaped hall ceiling is a composite picture, whereby transition regions between the single pictures projected by the individual projectors are hardly detectable or not detectable at all by the audience.

In a further embodiment of the invention the complete picture, which is created on the wall, which is circular in cross-section, and on the dome-shaped hall ceiling, consists on one hand of a composite picture generated on the wall, which is circular in cross-section, and on the other hand of another composite picture on the dome-shaped hall ceiling. For example, the pictures of a cinema film are projected onto the wall, which is circular in cross-section, and the pictures of a suitable sky (e.g. a star-lit sky) are projected on the dome-shaped hall ceiling.

All projectors, which are assigned to the projection surfaces and to the dome-shaped hall ceiling, are controlled by a common central control unit and thus their pictures are matched and synchronized to one another.

According to the invention the theatre hall comprises devices for influencing the central control unit. They enable the interaction of the whole or part of the audience in the events taking place in the theatre hall. Due to this possibility of interacting with the picture and/or sound presentation via the devices for influencing the central control unit, the whole impression of the audience in the theatre hall according to the invention is further reinforced.

In a preferred embodiment of the invention the devices for influencing the central control unit are multi-media interfaces, in particular joysticks located at least some of the audience seats in the theatre hall and/or which can be transported into the theatre hall.

Preferably, the devices for influencing the central control unit include at least one sensor. Consequently, there is the possibility of controlling the central control unit not only through the active influence of the audience via the device (e.g. by pressing keys or moving a joystick in a certain direction), but rather also via quantities acquired by means of sensors and thus of interacting with the events in the theatre hall.

In a preferred embodiment of the invention, the at least one sensor contained in the device for influencing the central control unit acquires at least one quantity from the group of acoustic signals (noise level in the theatre hall, tones, sounds), eye or pupil movement of a participant located on an audience seat assigned to the respective device for influencing the central control unit, the participant's body heat, movement of the participant or odours, whereby the acquired quantity is transformed into a signal for influencing the central control unit. The signal is used for example to influence the film events, the sound effects, the light and the seats or stage in the theatre hall according to the invention by means of the central control unit.

For example, the audience can influence the events on the projection surfaces by the noise level in the theatre hall according to the invention. In this respect, for example, agreement on a certain turn of events in a film can be signaled by a high noise level from the audience. Sensors integrated into one or more devices measure the noise level which is transformed into a signal which in turn influences the central control unit such that the desired turn of events in the film is brought about.

In a further preferred embodiment of the invention the devices for influencing the central control unit are mobile radios or devices based on mobile telephone technology. Here, these may be the private mobile telephones of the members of the audience or devices provided in the theatre hall. Mobile radio or devices based on mobile telephone technology have the advantage that they do not require any wiring in the theatre hall. The members of the audience operating these devices are free to move in the theatre hall with the device for influencing the central control unit and can thus, for example, be better integrated into the events (in particular when they are called onto a stage optionally provided in the theatre hall).

Further possible devices for influencing the central control unit are gaming devices. The respective device for influencing the central control unit can exhibit an integrated screen, optionally a touch screen, which can display a picture as an aid in operating the device. Furthermore, the device can also comprise loudspeakers. The devices for influencing the central control unit are linked via cables or radio to the central control unit and optionally to one another.

Several variants are conceivable for the evaluation of the signals passed to the central control unit by the devices for influencing the central control unit. One possibility is a priority controller with which always the signal of the first operated device for influencing the central control unit has priority. A further possibility is the evaluation of all signals of the device for influencing the central control unit and the determination of a signal representing the majority of these signals. Also conceivable is the enabling in each case of a certain device for influencing the central control unit at respectively certain times in the events in the theatre hall according to the invention.

In a further embodiment of the invention several distributed light sources and/or loudspeakers controllable from the central control unit are located in the theatre hall. A high intensity visual and acoustic overall impression is produced through the control of all projectors arranged in the theatre hall according to the invention and of the loudspeakers and/or light sources distributed in the theatre hall via a common central control unit.

In a preferred embodiment of the invention the theatre hall according to the invention comprises a large number of distributed, rotatable audience seats, optionally adjustable in height and which can be optionally tilted. The rotating feature of the audience seats enables the audience participant to face the events occurring in the theatre hall in any direction and to comprehensively register the picture which surrounds him over 360°. Fixed installed, non-rotatable audience seats are also however conceivable. Furthermore, due to the tilting feature, it is possible, for example, to comfortably observe pictures on the dome-shaped hall ceiling.

Preferably, the audience seats can be controlled by the central control unit. For example, the rotated angle can be adjusted mechanically and the tilt angle hydraulically. The audience seats are controlled by the central control unit such that the seating position, which influences the audience participant's viewing direction, steers the participant's attention to scenes which are important for the events in the theatre hall. Furthermore, the hydraulic height adjustment, e.g. for vibrations or lowering the audience seat, can be used such that the audience participant receives an even more intensive impression.

In a preferred embodiment of the invention the projection surfaces forming the circular cross-section wall are transparent and the assigned projectors are arranged behind the projection surfaces. Here, the disadvantages of front projection imaging systems can be avoided. If the projectors and the projected picture are located on the same side of the projection surface, the possible position and movement of the observer are restricted. Blocking of the projected light beams must be avoided and the projectors themselves take up part of the volume of the theatre hall. In contrast, with the preferred rear projection technology the complete internal volume of the theatre hall is available for use. Here, the projectors arranged behind the projection surfaces produce pictures which can be viewed from their front side.

In a preferred embodiment of the invention the projectors assigned to the dome-shaped hall ceiling are positioned at any spacing, preferably at equal spacing to one another, in the interior of the theatre hall at the lower edge of the dome-shaped hall ceiling. Here, for example, six or eight projectors installed at the lower edge of the dome can illuminate the complete hall ceiling.

In a preferred embodiment of the invention the projectors assigned to the dome-shaped hall ceiling are connected via optical wave guides to the light sources, which are preferably lasers. The use of optical wave guides facilitates an arrangement of the light sources at a place outside of the theatre hall so that they do not take up any space in its internal volume and can be optionally sited free of vibration. The projectors therefore only have a small volume and light weight so that they can be installed in the theatre hall without problem. Lasers are preferably used as light sources, in particular lasers which emit in the three primary colours of red, green and blue so that pixels of any colour can be produced on the hall ceiling.

In a preferred embodiment of the invention the projectors assigned to the dome-shaped hall ceiling contain moving mirrors for the targeted deflection of light signals for generating pictures on the dome-shaped hall ceiling. With this arrangement light signals from the light sources assigned to the projectors, in particular laser pulses, can be specifically deflected and focused on certain points on the hall ceiling. By means of this technology a picture can be created point by point and line by line on the dome-shaped hall ceiling of the theatre hall according to the invention.

In a preferred embodiment of the invention the theatre hall according to the invention comprises hydraulically moveable performance surfaces which can be controlled from the central control unit. These performance surfaces are provided for live artists and/or musicians, who preferably act in conjunction with pictures generated on the projection surfaces of the dome-shaped hall ceiling or with the sound produced from the loudspeakers. The presentations of real and artificially generated scenes, simultaneously matched to one another, lead to a further increase in the overall impression. Controlled from the central control unit, the performance surfaces can, for example, be moved hydraulically, e.g. perpendicular to the floor of the theatre hall.

In a preferred embodiment of the invention the dome-shaped hall ceiling is based on the principle of air-inflated structures. This type of hall ceiling facilitates the design of the theatre hall according to the invention as part of a transportable building, which can be taken down without problem at one place and set up again at another place.

The invention is explained in more detail in the following, based on the drawing.

The following are shown:

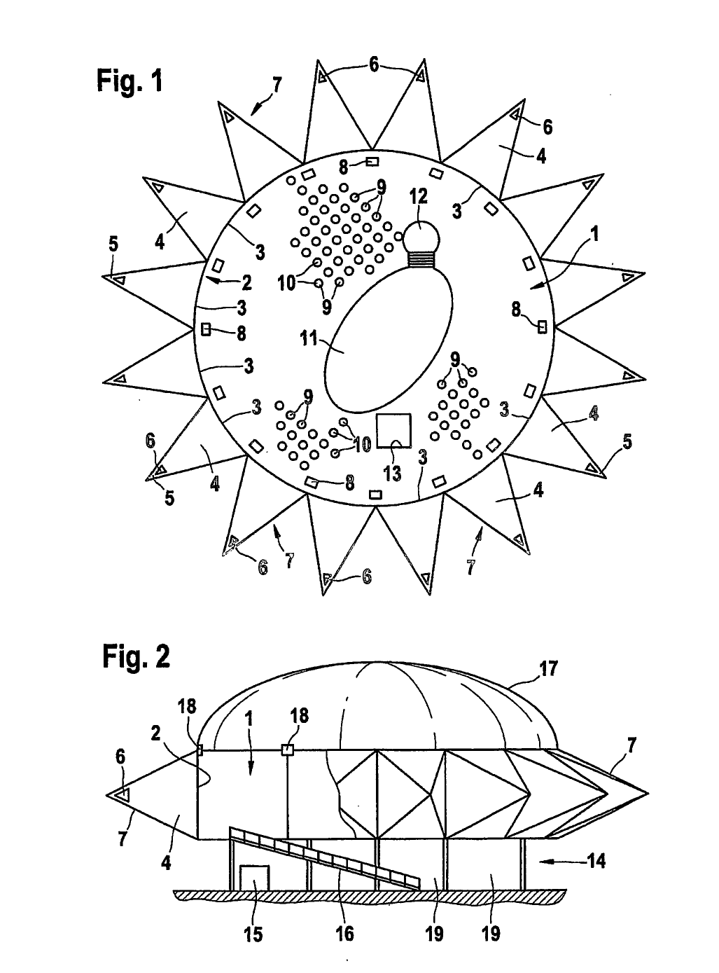

FIG. 1 a plan of the theatre hall according to the invention and

FIG. 2 a partially sectioned side elevation of a building containing the theatre hall according to the invention.

FIG. 1 shows a plan of a theatre hall according to the invention. The auditorium 1 is surrounded by a wall 2 which is circular in cross-section. The diameter of the auditorium 1 is for example approx. 51 m. The wall 2 with a circular cross-section is taken up over its complete height by the projection surfaces 3. The height of the wall 2 is, for example, 10 m. In the embodiment of the theatre hall according to the invention shown in FIG. 1, it is formed by sixteen 10 m wide projection surfaces 3. The projection surfaces 3 are transparent and are respectively directly adjacent to one another. The larger the diameter of the auditorium 1, the less the curvature of the projection surfaces 3, which must be taken into account for the projection of pictures.

On the side facing away from the auditorium 1 there is located, starting from each projection surface 3, a chamber 4 which runs into a point 5 which is located on a straight line running through the centre of the respective projection surface 3. In the vicinity of the point 5 a projector 6 assigned to the projection surface 3 is installed, which projects pictures into the transparent projection surface 3. The side surfaces of the chambers 4 running to a point form the outer walls 7 of the theatre hall according to the invention.

The auditorium 1 furthermore contains loudspeakers and light sources 5 which are arranged evenly distributed. They are preferably mounted at the upper edge of the wall 2.

Furthermore, the theatre hall according to the invention comprises rotatable audience seats 8, of which only some are drawn in FIG. 1. At least one part of the audience seats 9 is in this embodiment of the theatre hall according to the invention equipped with devices 10 for influencing a central control unit (not illustrated) for controlling the events in the theatre hall, whereby these devices are preferably joysticks or mobile radio devices.

The audience seats 9 surround a performance surface 11, which is provided for live performances. The performance surface 11 is preferably hydraulically movable (in particular in the vertical direction). To move the performance surface 11, it is controlled from the central control unit (not shown). A further performance surface 12 for musicians is located next to the performance surface 11. This can also be controlled by the central control unit and can be moved hydraulically. In this preferred embodiment of the theatre hall according to the invention the performance surface 11 has an oval shape for the live performers and the performance surface 12 has a round shape for the musicians.

A floor aperture 13, which is connected to a ramp arranged in the lower storey, provides access to the auditorium 1 located in the upper storey of the theatre hall according to the invention illustrated in FIG. 1. However, access through a door arranged in the wall with a circular cross-section or any other access would be conceivable.

FIG. 2 illustrates a partially sectioned aide elevation of a building containing the theatre hall according to the invention illustrated in FIG. 1.

The theatre hall forming the upper storey of the building rests on a substructure 14, the wall 19 of which preferably comprises large glass surfaces. This produces transparency of the substructure 14 and a suspended impression is given to the theatre hall forming the upper storey. However, a theatre hall according to the invention arranged on the ground-floor without a substructure 14 is also conceivable.

In the substructure 14 the central control unit 15 is located, which can be influenced by the audience using the device 10 for influencing the central control unit and which controls all the projectors, loudspeakers, performance surfaces, light source and optionally also the audience seats arranged in the theatre hall. In another embodiment (not illustrated) of the invention the central control unit 15 can also however be arranged in another building, optionally at a remote location, optionally at a remote location, and can communicate with the theatre hall according to the invention via cable or radio.

An access ramp 16, which terminates in the floor aperture 13 in the auditorium 1 and via which the audience enter the auditorium 1, runs diagonally through the substructure 14. An escalator or in another embodiment a lift or a moving walkway can for example be used as access.

The theatre hall according to the invention further comprises a dome-shaped hall ceiling 17, which is formed as a reflecting projection surface. In conjunction with the projection surfaces 3 on the wall 2 of the auditorium 1, the dome-shaped hall ceiling 17 forms an imaging system, enclosing the audience, for creating an impressive overall picture. The projectors 18, which are assigned to the dome-shaped ceiling 17, are positioned in this embodiment at the lower edge of the dome-shaped hall ceiling. They can also be controlled through the central control unit 15. They can however also be positioned differently, for example behind the hall ceiling or in the interior of the theatre hall.

### LIST OF REFERENCE SYMBOLS

1 Auditorium
2 Wall with a circular cross-section
3 Projection surfaces
4 Chamber
5 Point
6 Projector
7 Outer walls
8 Loudspeakers and light sources
9 Audience seats
10 Devices for influencing the central control unit
11 Performance surface for live performers
12 Performance surface for musicians
13 Floor aperture
14 Substructure
15 Central control unit
16 Access ramp
17 Dome-shaped hall ceiling
18 Projectors
19 Wall

1. Theatre hall with a wall (2) with a circular cross-section formed by several adjacent defining projection surfaces (3) and comprising projectors (6), wherein at least one projector (6) is assigned to each projection surface (3), and with a dome-shaped hall ceiling (17) to which several projectors (18) are assigned, wherein all projectors (6, 18) can be controlled from a common central control unit (15) such that a complete picture arises on the wall (2) with a circular cross-section and on the dome-shaped ceiling (17), and with devices (10) for influencing the central control unit (15).

2. Theatre hall according to claim 1, characterized in that the devices (10) for influencing the central control unit (15) are joysticks, which are located at least some of the audience seats (9) arranged in the theatre hall or which can be transported into the theatre hall.

3. Theatre hall according to claim 1, characterized in that the devices (10) for influencing the central control unit (15) contain at least one sensor.

4. Theatre hall according to claim 3, characterized in that the sensor acquires at least one quantity from the group of acoustic signals (noise level in the theatre hall, tones, sounds), eye or pupil movement of a participant, the participant's body heat, movement of the participant or odors, wherein the acquired quantity is transformed into a signal for influencing the central control unit (15).

5. Theatre hall according to claim 1, characterized in that the devices (10) for influencing the central control unit (15) are mobile radio devices or are based on mobile telephone technology.

6. Theatre hall according to claim 1, characterized by several distributed light sources and/or loudspeakers (8) which can be controlled from the central control unit (15).

7. Theatre hall according to claim 1, characterized by a large number of distributed, rotatable audience seats (9), optionally adjustable in height and which can be optionally tilted.

8. Theatre hall according to claim 7, characterized in that the audience seats (9) can be controlled by the central control unit (15).

9. Theatre hall according to claim 1, characterized in that the projection surfaces (3) forming the wall (2), which is circular in cross-section, are transparent and the assigned projectors (6) are arranged behind the projection surfaces (3).

10. Theatre hall according to claim 1, characterized in that the projectors (18) assigned to the dome-shaped hall ceiling (17) are spaced with respect to one another in the interior of the theatre hall at the lower edge of the dome-shaped hall ceiling (17).

11. Theatre hall according to claim 1, characterized in that the projectors (18) assigned to the dome-shaped hall ceiling (17) are connected via optical wave guides to light sources, in particular to lasers.

12. Theatre hall according to claim 1, characterized in that the projectors (18) assigned to the dome-shaped hall ceiling (17) contain moving mirrors for the specific deflection of light signals for creating pictures on the dome-shaped hall ceiling (17).

13. Theatre hall according to claim 1, characterized by hydraulically movable performance surfaces (11,12) which can be controlled from the central control unit (15).

14. Theatre hall according to claim 1, characterized in that the dome-shaped hall ceiling (17) is based on the principle of air-inflated structures.
